(19) United States
(12) Patent Application Publication
(10) Pub. No.: US 2007/0025360 A1
(43) Pub. Date: Feb. 1, 2007

(54) Secure distributed system for management of local community representation within network devices

(76) Inventors: Nicolas Prigent, Rennes (FR); Olivier Heen, Domloup (FR); Jean-Pierre Andreaux, Asterdam (NL); Christophe Bidan, Thorigne Fouillard (FR)

Correspondence Address: THOMSON LICENSING INC., PATENT OPERATIONS, PO BOX 5312, PRINCETON, NJ, 08543-5312, US

(21) Appl. No.: 10/552,138

(22) PCT Filed: Apr. 13, 2004
(86) PCT No.: PCT/EP04/03863

§ 371 Date: Jul. 10, 2006

(30) Foreign Application Priority Data
Apr. 11, 2003 (EP) 03290920.2

(51) Int. Cl. H04L 12/56

(52) U.S. Cl. 370/397; 713/168

(57) ABSTRACT

A new system for creating and updating a secure community of devices in digital networks is disclosed. A device adapted to belong to a community of networked devices contains; a provable identity and/or means for generating and/or obtaining a provable identity; means adapted to store information about devices of the community having trust relationships with the device; means adapted to store information about devices not trusted by this device; and means for trust relationships synchronization.

### FIELD OF THE INVENTION

The invention applies to digital networks, especially when they are dynamical, evolutive, heterogeneous, and when they contain wireless parts.

### BACKGROUND ART

### DEFINITIONS

A network is dynamic when devices can move, be on/off, be reachable or not.

A network is evolutive when new devices may join the network, older devices may definitively disappear from the network or be stolen.

A network is heterogeneous when not all devices are able to directly communicate by pairs.

A community is a network composed of devices under the responsibility of a main user. The main user is either a single user or a specific user within a group of persons. Only the main user is able to authenticate against community devices in order to perform the validation operation required by the system.

The frontier of a community is defined following its characteristic properties:
Any device in the community can verify that it belongs to the community.
Any device in the community, can verify whether any other device also belongs to the community or does not belong to the community.
Only the main user can perform frontier operations such as inserting or removing devices from the community.

Prior Art

Most prior art comes out from the field of Company Wide Digital Networks, Ad-Hoc Networks (i.e. networks with no pre-existing infrastructure, generally build for the specific use of a group of person—Ad-hoc network duration does not exceed group duration), Digital Home Networks, Wireless and Mobile Networking.

The first communities corresponded to a basic model: the community frontier were identical to network frontier. If a device was reachable through the network, then it was a member of the community. Conversely, any device that was not reachable through the network was not a member of the community.

Such communities exactly correspond to isolated Local Area Networks (LAN) as they were used in companies, before the need to connect un-trusted networks (such as the Internet).

In these communities, the security of the frontier relies on two main factors:
Only authorized users are able to use a device and the network.
No un-trusted device can be inserted on the network.

Both factors were enforced by the role of a main user (called a network administrator) and the location of devices and network in a secure place.

These communities are not adapted in cases where the network is mobile or needs to cross un-trusted devices. Administrative tasks are also very demanding, and generally not accessible to a typical domestic main user. Last, the security model is not fault-resistant as all the community is compromised as soon as one of its members is compromised.

When the need for communication over un-trusted networks arose, the former paradigm didn't suffice. Frontier had to be materialized in a different way, that would take in account the possibility to cross non-trusted networks, such as the Internet.

This gave birth to frontier components such as secured routers and firewalls, as well as the notion of private addressing domains. Such components enforce correct frontier properties by allowing or denying cross-frontier access. Typical architecture is a diode firewall allowing outgoing connections and forbidding incoming connections.

The security of the frontier of such community relies mostly on the ability of frontier components to detect whether external connections are authorized or not. Inside the network, the security relies on the same two factors (authorized access and no un-trusted device insertion).

These communities are not adapted in cases where the network is very evolutive or when a lot of devices have a nomadic behavior.

Cross-Network communities really started with nomadic behaviors, when a device needs to access the community from an external network location. Firewall helped enforcing frontier properties, together with authentication servers.

Protocols such as IPv6 (New version of Internet Protocol, as specified in “RFC 2460 Internet Protocol, Version 6 (IPv6) Specification. S. Deering, R. Hinden. December 1998”) and some VPN (Virtual Private Network) technologies include mobility and security function that help securing communities frontiers. These include HIP (described in “R. Moskowitz, Host Identity Payload And Protocol, draft-ieff-moskowitz-hip-05.txt, October 2001”, available at the following address: http://homebase.htt-consult.com/˜hip/draft-moskowitz-hip-05.txt) and SUCV (described in “C. Montenegro and C. Castelluccia. Statistically Unique and Cryptographically Verifiable (SUCV) identifiers and addresses. In NDSS'02, Feb. 2002”). In this case however, the complexity is not manageable by a typical domestic user. Moreover, these technologies rely on devices homogeneity (for instance: each device has a valid IPv6 address).

F. Stajano proposed a more generic method: the Resurrecting Duckling (in “F. Stajano The Resurrecting Duckling-What Next? Lecture Notes in Computer Science, 2133:204-211, 2001” and in “F. Stajano and R. Anderson. The resurrecting duckling: Security issues for ad-hoc wireless networks. In 7th International Workshop on Security Protocols, pages 172-194, 1999.”). In this method, however, the main user must validate operations whenever a new device is added to the community. Moreover, banishment of a device from the community is not an easy operation in the general case.

The main problems when managing and securing community frontiers are:
Complexity and lack for user friendliness at least in regard to domestic user needs. This is mostly true for firewalls (even personal firewalls) that remain complex if a fair security level is to be achieved.
Need for heterogeneity: most existing methods fail when not all devices are able to communicate by pairs.
Lack of robustness when devices are compromised or stolen.
More precisely, a posteriori revocation (banishment) of a device is not a simple action in most existing methods.

### SUMMARY OF THE INVENTION

In order to overcome the above-mentioned problems, the invention proposes a system for the secure and distributed management of a local community representation within network devices, characterized in that each network device contains:

a provable identity or means to generate or to obtain a provable identity;

objects capable of memorizing identities of devices of the community having trust relationships with said device; and

means for establishing a protocol for trust relationships synchronization.

### BRIEF DESCRIPTION OF THE DRAWINGS

The various features and advantages of the present invention and its preferred embodiments will now be described with reference to the accompanying drawings which are intended to illustrate and not to limit the scope of the present invention and in which:

FIG. 1 illustrates parts of a device implementing the invention.

FIG. 2 illustrates an example of a community created according to the invention.

FIGS. 3 to 7 illustrate a flowchart of the preferred protocol executed in a device z according to the invention.

FIGS. 8 to 12 are temporal diagrams illustrating different possible situations between devices implementing the protocol illustrated in FIGS. 3 to 7.

### DETAILED DESCRIPTION OF THE PREFERRED EMBODIMENTS

In the following of the description, the following notation will be used:

a, b, c, d, x, y, z, t, j Variable names for devices.

idₓ Provable identity of device x.

Λ Community of devices.

MT(x), UT(x), DT(x) Sets of devices.

Sₓ(id_{y}) Proof that device y is trusted by device x. This proof can be verified if one knows idₓ. Knowing idₓ, it is possible to verify that Sₓ(id_{y}) has been generated by x and it is possible to recover id_{y}.

The invention is based on the following elements:
1. Each device x of the community has a provable identity idₓ or is able to generate or to receive a provable identity.
2. Each device x of the community memorizes trust relationships between devices of the community in objects MT(x), UT(x) and DT(x) respectively containing:
   MT(x): a set of devices trusted by x AND trusting x.
   UT(x): a set of devices trusted by x.
   DT(x): a set of devices distrusted by x.
3. Each device x of the community furthermore memorizes proofs Sⱼ(idₓ) received from other devices j of the community that x is trusted by j.
4. A protocol for trust relationships synchronization is implemented in each device of the community.
5. The user has the possibility to validate or invalidate trust relationships between some devices.

First, the invention allows distributed and secure enforcement of community frontiers.

Second, the invention minimizes the number and complexity of interactions between community devices and the main user.

Preferably, objects MT(x), UT(x) and DT(x) are implemented by lists containing provable identities idⱼ of the devices j which are part of the set.

For example if a device x trusts a device y and is trusted by y, MT(x) will contain id_{y}. MT(x) may also possibly contain some cryptographic material, such as keys to allow devices of the community to securely exchange data. In the above example, MT(x) may contain a symmetrical key K_{xy} shared between devices x and y.

In a preferred embodiment of the invention, the list of proofs Sⱼ(idₓ) may be stored in MT(x), each proof Sⱼ(idₓ) being stored with the identity idⱼ of the device trusting x and trusted by x. In a variant embodiment, proofs Sⱼ(Idₓ) are stored in another list of data.

In the same way, if a device x trusts a device z but is not necessarily trusted by z, then UT(x) will contain id_{z}. UT(x) may also contain some cryptographic material.

DT(x) also contains identities idⱼ of devices j which are distrusted by x. It may also possibly contain other data such as cryptographic material.

Basic community operations are:
Initialization of a community, denoted init:
   The init operation corresponds to the creation of the community, generally with a single device.
Insertion of device in a community, denoted insert:
   The insert operation occurs when a new device enters the community. This new device should be able to identify the other devices of the community as belonging to the community and the other members of the community should identify the new device as a member of the community.
Removal of a device from a community, denoted remove.
   The remove operation shall be used when a device is obsolete. This operation will extract the device from the community, but will not modify trust relations. In particular, in the case when two devices y and z build a trust relationship upon the assumption that both devices have trust relationships with device x, the fact that device x has been removed has no impact.
   Then the remove operation does not require any information transmission with other community devices. In particular, this operation is valid in the case of a single device community.
   Removing a device x consists in:
      Destroying x identity (idₓ) and the ability for x to prove this identity.
      Resetting all trust relationships, that is making all sets MT(x), UT(x), DT(x) empty.
   After removal, the device x is unable to broadcast its identity (which has been destroyed). He cannot take any part in community devices transmissions as no community device accepts a transmission with unidentified device.
Banishment of a device from a community, denoted banish.
   The banish operation shall be used when a device has been lost or stolen, or when a device is resold to another user, from another community. In this case, the device itself is not available. Moreover, new trust relationships that can be build upon trust assumptions with the banished device shall become impossible. To banish a device x, the user must select another available device y that already has a trust relationship with x (i.e. its identity idₓ belongs either to UT(y) or MT(y)). The user asks y to add {idₓ} in its list of distrusted devices DT(y).
   The synchronization operation will insure diffusion of the information that device x is distrusted. Depending on how often devices of the community interact, this information may diffuse faster over some devices, and slower over all devices.
   Thanks to the invention, it is therefore possible to banish a device x from a community by using only one other device y of the community.

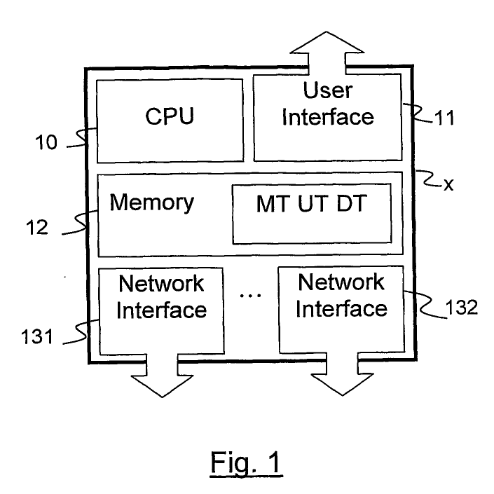

FIG. 1 illustrates which elements are contained in a device for implementing the invention.

A device x typically contains a CPU (Central Processing Unit) 10, a User Interface 11, a memory 12 for storing objects MT(x) UT(x) and DT(x) as well as the list of proofs Sⱼ(idₓ) received from other devices j of the community that x is trusted by j. The device furthermore contains at least one network interface 131, 132 for communication with other devices of the community. One device may contain several network interfaces in order to allow heterogeneous communications in the community.

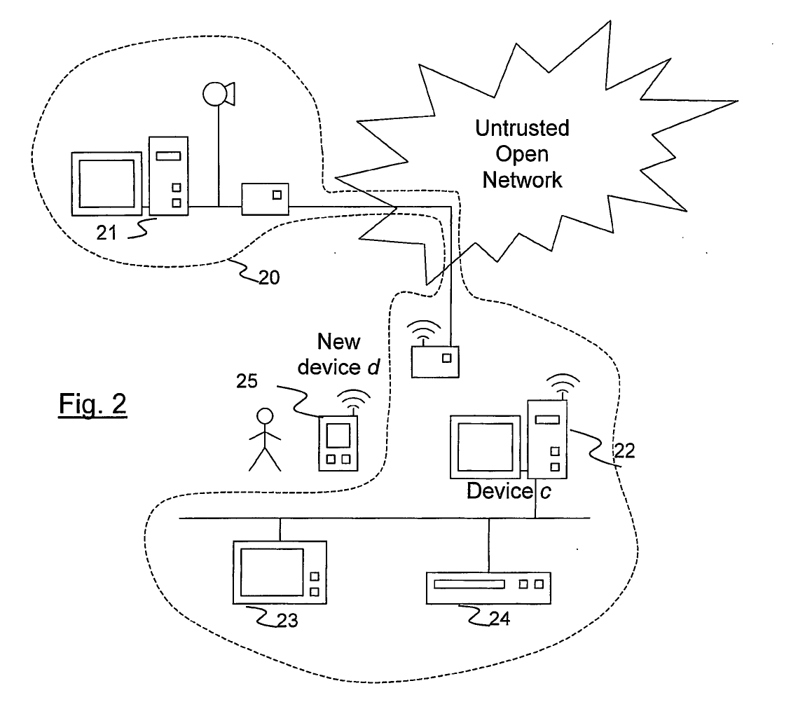

FIG. 2 illustrates an example of a community 20 of devices represented by a multi-site domestic network. Devices are for example a Personal Computer 21, 22, a TV set 23, a storage unit 24, a PDA (Personal Digital Assistant) 25, etc. In the situation of FIG. 2, we suppose that all trust relationships between devices are mutual trusts. FIG. 2 illustrates the moment when device c is about to accept a new device d in the community, with user validation.

In the preferred embodiment of the invention, each device contains a local agent responsible for its security. The first task of the agent is to manage its own provable identity. A provable identity is an identity that has the property of being able to be checked by anyone, while being very hard to impersonate. For instance, the public key of a public/private key pair is a provable identity: an agent pretending being identified by its public key can prove it by signing a challenge with its private key. SUCV is another mechanism designed for IP networks based on the idea of provable identity.

The local agent is in charge of generating, escrowing and endorsing its provable identity that will be used to authenticate itself in front of the other devices of the community.

The agent is also in charge of locally authenticating the user who makes authority on the device to ensure that the security-relevant requests are legitimate. This local authentication is totally independent from its own provable identity as well as from the keying process that is made between devices. As a consequence, each device can have its own best-suited authentication procedure (for example by entering a PIN on the device or by biometrics).

Finally, the agent is in charge of community management. It possesses and maintains its own list of the community members, which are stored in objects MT, UT and DT described above. Depending on the implementation chosen, these objects can be stored in a single list or in different lists. This list or theses lists describe(s) the local knowledge the agent has of its community. By securely updating the content of objects MT, UT and DT, an agent manages its community.

Objects MT, UT and DT can be updated by two different means: an agent trusts its owner (i.e. the user who owns the device) to decide which device can enter in its community. It also trusts the agents it knows as belonging to its community (i.e. the agents having their provable identity in its MT or UT), to introduce to him new members of the community. Agents belonging to the same community synchronize their information with each other in a secure way to maintain their respective objects MT, UT and DT up to date.

The agent can be physically implemented in several different ways.

It may be a software either downloaded or embedded in the device. It can also be a software running in a smart card inserted in the device. The agent can also be implemented by a chip or chip set containing a software.

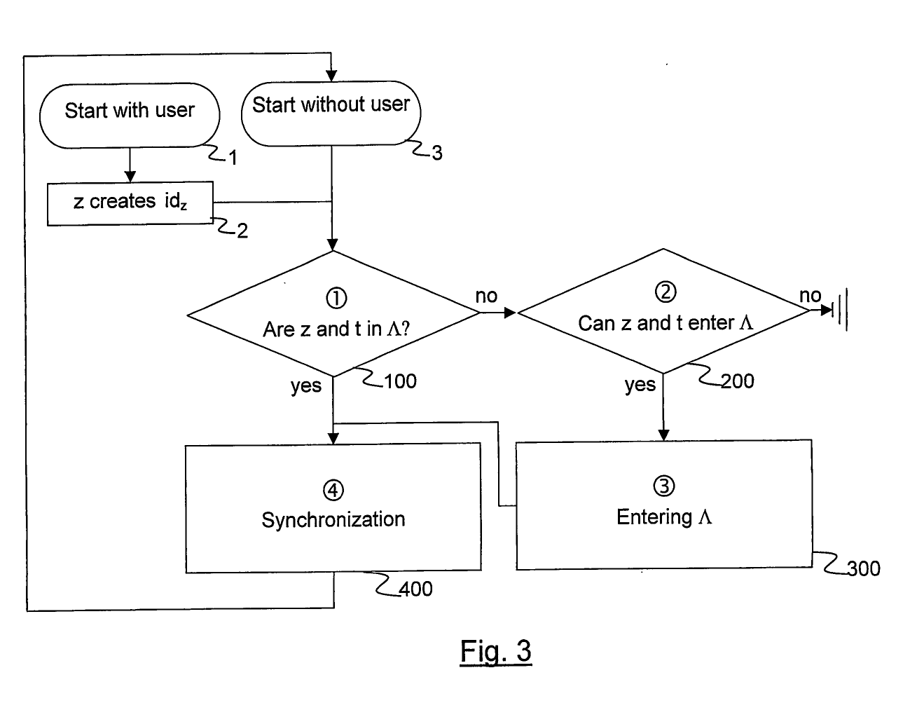

We will now describe more precisely the protocol implemented in a device z according to the invention. This protocol is described in view of FIGS. 3 to 7.

In addition to the notation previously described, the following notations are used in these figures:

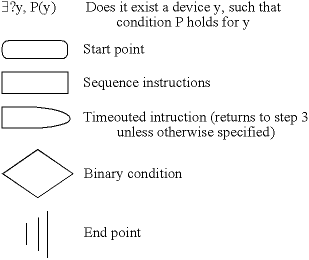

Step 1 in FIG. 3 is a start point used when the main user just acquired a device z with no identity id_{z}.

Step 1 is followed by step 2 during which all necessary operations for device z initialization are performed. This includes: software code insertion (unnecessary for chip implementation), creation of cryptographic key material, creation of the provable identity id_{z} of the device z, set up of lists MT(z), UT(z) and DT(z) to empty. It is to be noted that one initialization operation may necessitate the intervention of the main user. Step 2 is followed by step 100.

The protocol may also start with step 3 which is a normal start point for an already initialized device z. Step 3 is also followed by step 100.

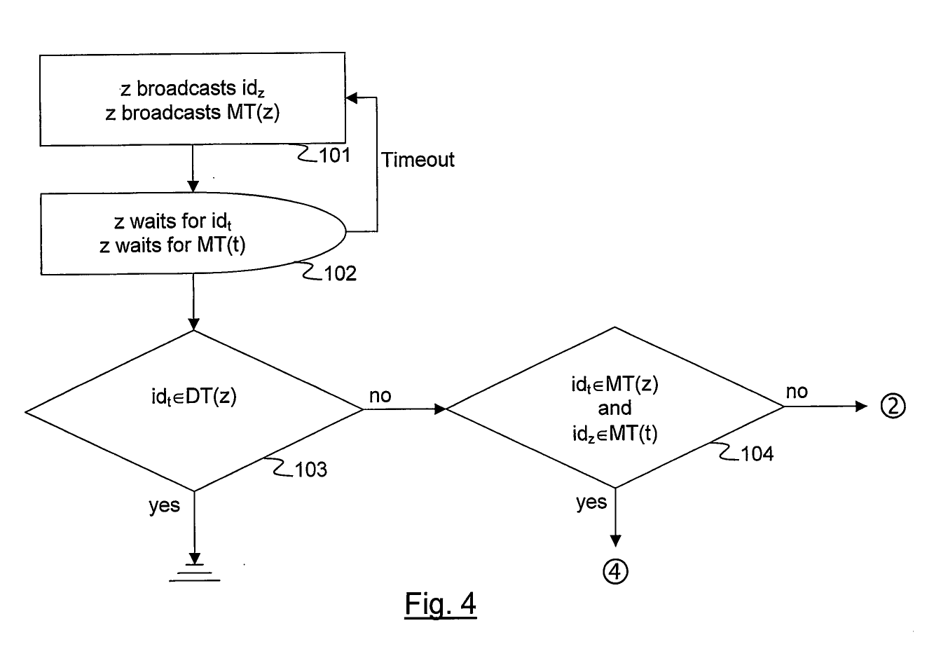

Step 100 contains all operations and conditions necessary for a device z to detect whether another device t belongs to the same community A or not. Details for these operations are given in sub-steps 101 to 104 (in FIG. 4).

At step 101, the device z sends information by any available mean (including wired or wireless network protocols) to all other devices possibly belonging to the same network. The broadcast information is: id_{z} and MT(z).

Step 101 is automatically followed by step 102 during which the device z waits and listens to all its network interfaces, until it obtains an identity idₜ and an object MT(t) from a device t (case 1) or until a timeout expires (case 2). Typical timeout duration in the case of domestic network is one or two minutes. If the case 1 occurs then the protocol continues with step 103 else (case 2) it goes back to step 101.

Step 103 is activated if the information idₜ and MT(t) have been received from a device t. During this step, the device z verifies if it distrusts t or not. If so, the process stops and starts again with step 3, else it continues with step 104.

At step 104, i.e. if device z does not distrust device t, device z verifies if the identity idₜ belongs to MT(z) and if its identity id_{z} belongs to MT(t). If both verifications are successful then the process goes on with step 400 (in FIG. 3), else it goes on with step 200.

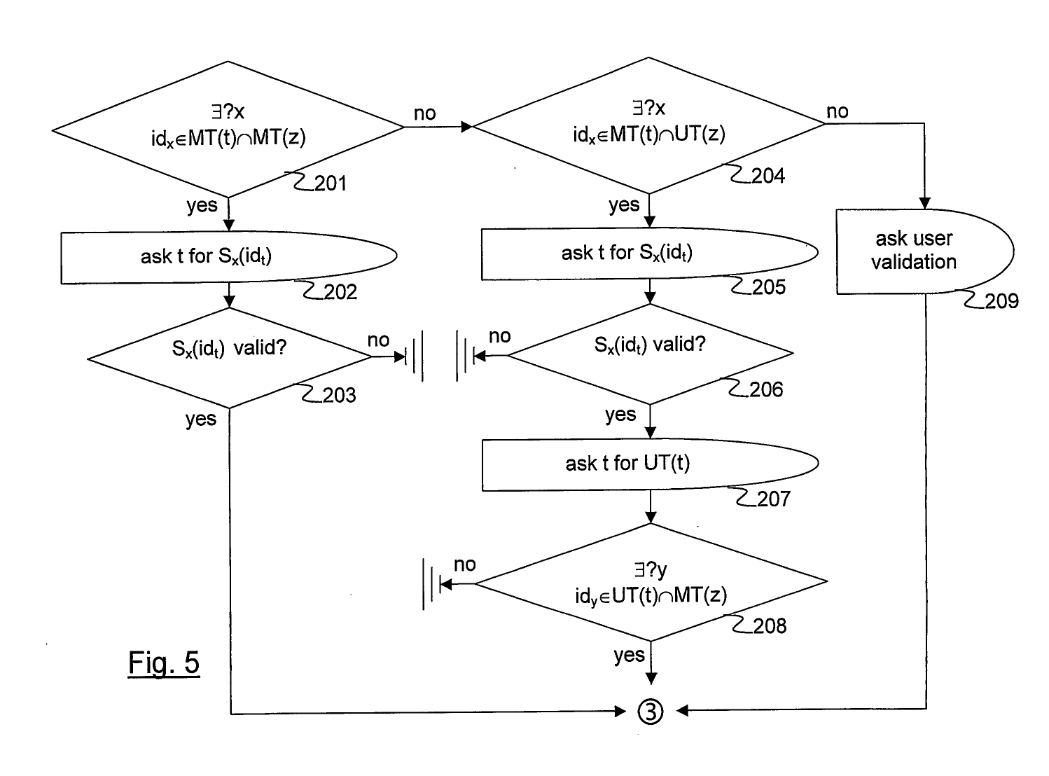

Step 200 is activated if device z has detected that a device t does not (already) belong to the same community. This step contains all operations and conditions necessary for device z to detect whether it can enter the same community as the device t's one. Details for these operations are given in sub-steps 201 to 209 (in FIG. 5).

At step 201, the device z verifies if it exists a device x such that idₓ belongs to the intersection of the lists MT(z) and MT(t). If so the next step will be 202 else it will be 204.

At step 202, the device z asks device t for Sₓ(idₜ), i.e. the proof that device t is trusted by device x. In case device z receives Sₓ(idₜ) from device t before the expiration of a timeout of typical duration 1 minute, the process goes on with step 203. Otherwise, if the timeout expires before reception of Sₓ(idₜ) by device z, the process stops and is started again at step 3 (FIG. 3).

At step 203, the device z receives Sₓ(idₜ) from device t and verifies it. At this point, device z knows idₓ (contained in MT(z)) and it has previously received idₜ (at step 102). The verification therefore consists in using device x public identity idₓ over Sₓ(idₜ) in order to recover idₜ and to compare it with idₜ previously received. If both identities idₜ match, the verification is successful and the next activated step will be 300 (FIG. 3). Otherwise, the verification is not successful, and the process stops and starts again at step 3.

Step 204 is activated if it does not exist any device x such that idₓ belongs to the intersection of the lists MT(z) and MT(t). During this step, the device z verifies if it exists a device x such that idₓ belongs to the intersection of the lists UT(z) and MT(t). If so the next activated step will be 205 else it will be 209.

At step 205, the device z asks device t for Sₓ(idₜ) and if it receives Sₓ(idₜ) before the expiration of a timeout of typical duration 1 minute, the next activated step will be 206. Otherwise, if the timeout expires before reception of Sₓ(idₜ) by device z, the process stops and is started again at step 3 (FIG. 3).

Step 206 is similar to step 203 and will not be described furthermore. If the verification of step 206 is successful then the process continues with step 207, otherwise, it stops and is started again at step 3 (FIG. 3).

At step 207 (activated if device z has successfully verified Sₓ(idₜ)), the device z asks device t for UT(t) (to be received within a timeout of typical duration 1 minute). The process then continues withstep 208. If the timeout expires before reception of UT(t), the process stops and is started again at step 3 (FIG. 3).

At step 208, the device z verifies if it exists a device y such that id_{y} belongs to the intersection of the lists UT(t) and MT(z). If so the process continues with step 300 (FIG. 3), else it stops and starts again at step 3.

Step 209 is activated after step 204 if it does not exist any device x such that idₓ belongs to the intersection of the lists UT(z) and MT(t). In this case, a main user validation is requested to go to the next step 300. This main user validation should occur within a timeout of typical duration 1 minute. If timeout expires, the process stops and starts again at step 3 (FIG. 3).

It is to be noted that the timeout used at steps 202, 205 and 209 has a typical duration of 1 minute, but the user can configure this duration.

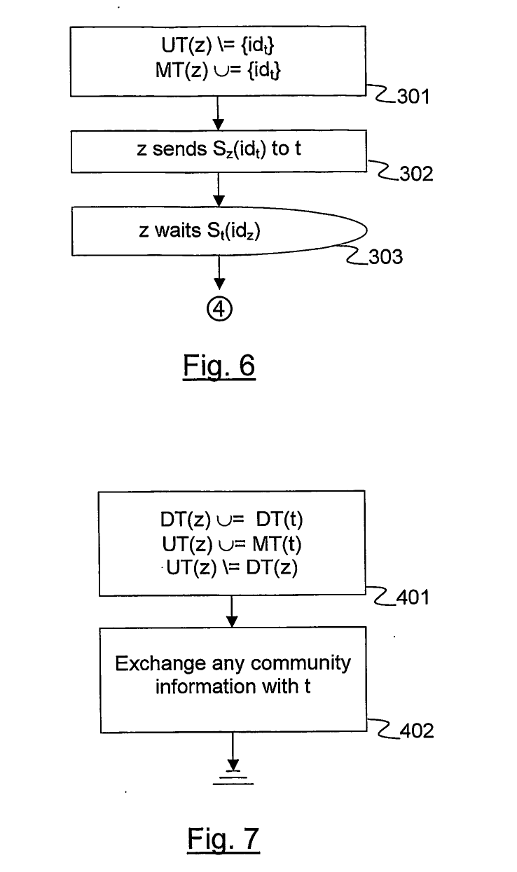

Step 300 in FIG. 3 is activated when device z has a proof that it can accept the device t in its community A. This step contains all operations and conditions necessary for device z to accept device t in its community. Details for these operations are given in sub-steps 301 to 303 of FIG. 6.

In step 301, lists UT(z) and MT(z) are updated as follows: idₜ is removed from to UT(z) and is inserted in MT(z). This step is followed by step 302.

In step 302, the device z sends the proof S_{z}(idₜ) that device t is trusted by device z to t. Then, in step 303, the device z waits for Sₜ(id_{z}) from t and it stores it for a later use (for proving to other devices that z is trusted by t). Then, the process goes on with step 400 (FIG. 3) unless a timeout, of typical duration 1 minute, expires before reception of Sₜ(id_{z}). In the later case, the process stops and starts again at step 3.

Step 400 (FIG. 3) is automatically activated after step 104 of FIG. 4 (when devices z and t already belong to the same community) or after step 303 of FIG. 6, (when device z has a proof that it can accept device t in its community). This step 400 contains all operations and conditions necessary for device z and device t to share and update community information. Details for these operations are given in sub-steps 401 to 402 of FIG. 7.

In step 401, lists DT(z) and UT(z) are updated as follows: elements of DT(t) are added to DT(z), elements of MT(t) are added to UT(z), elements of DT(t) are removed from to UT(z). This step is followed by step 402.

In step 402, the device z provides device t with all the community information it possesses. Then, the process is stopped and started again at step 3.

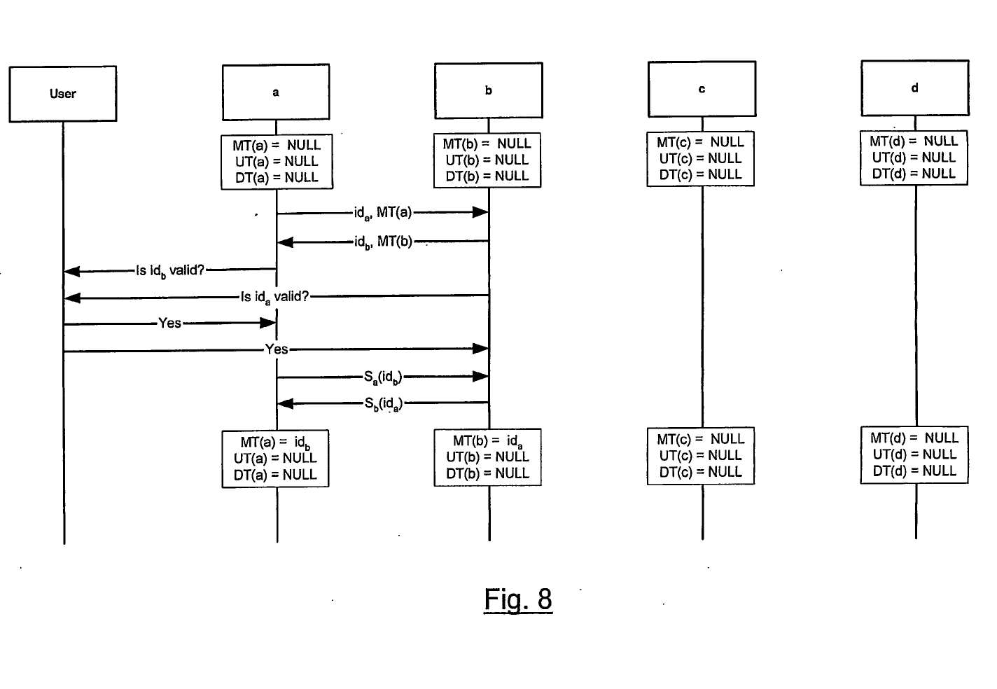

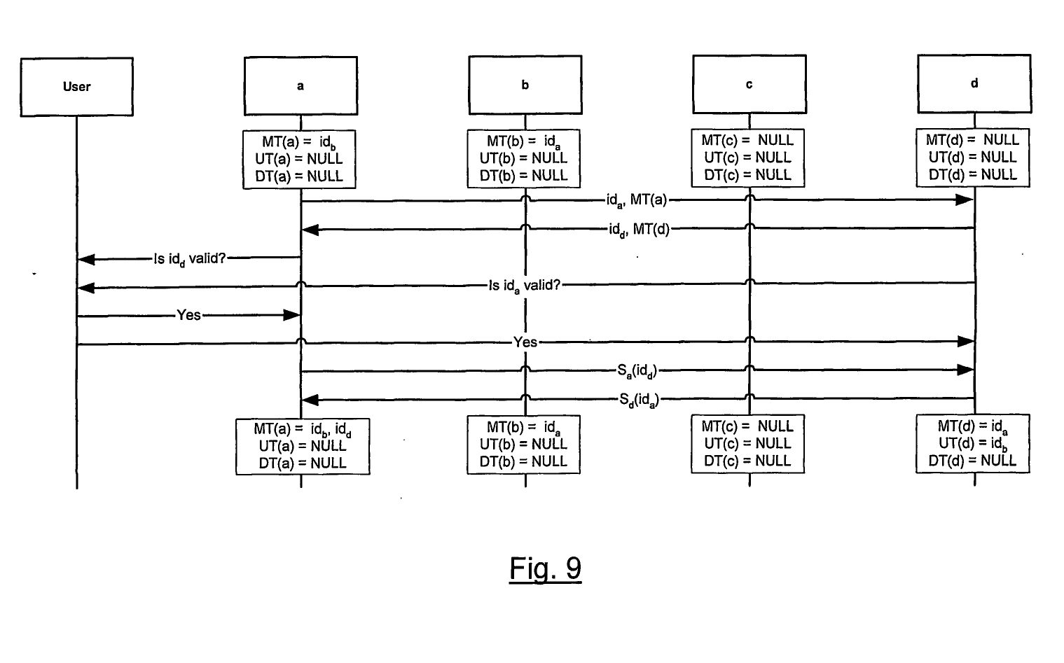

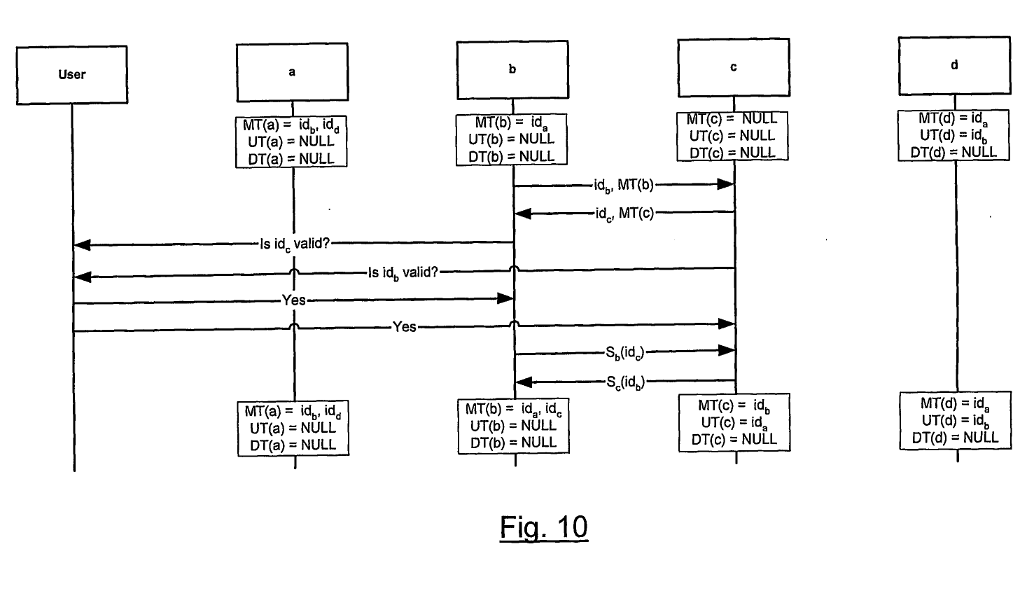

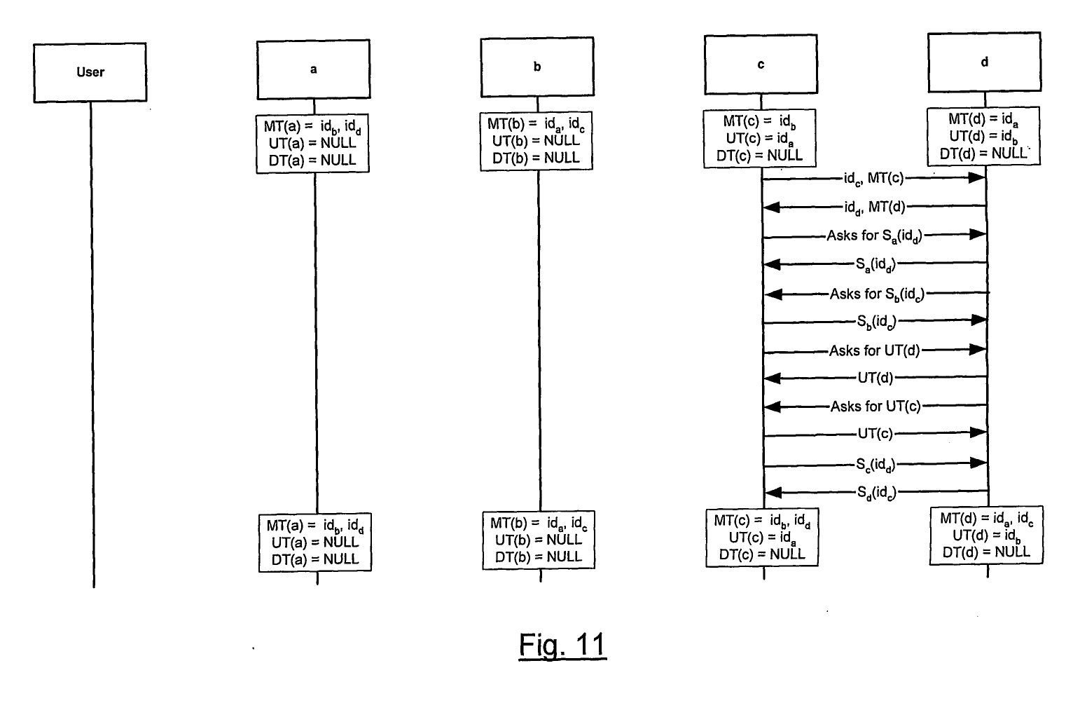

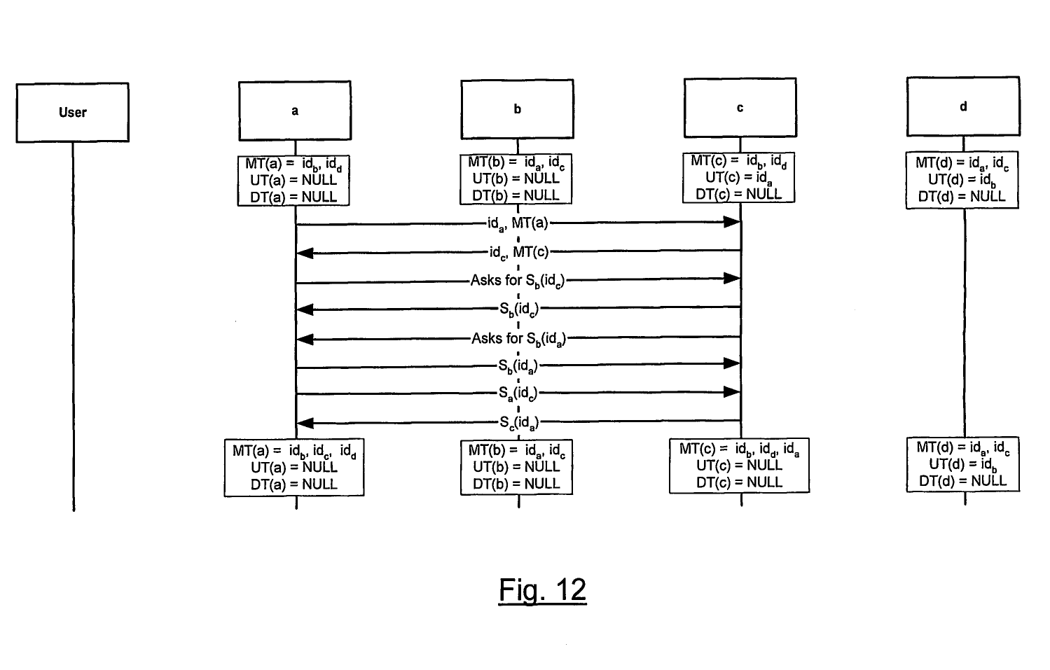

FIGS. 8 to 12 show an example of the evolution of a community. At first there is one device a which is alone in its community. Then the user will insert device b, then device d, then device c, in this order. More precisely:
FIG. 8 illustrates the operations when device b enters device a's community.
FIG. 9 illustrates the operations when device d enters device a's community.
FIG. 10 illustrates the operations when device c enters device b's community (which is also device a's community).
FIG. 11 illustrates the operations when devices c and d establish a trusted relationship without any user interaction (using steps 204 to 208 in FIG. 5).
FIG. 12 illustrates the operations when devices a and c establish a trusted relationship without any user interaction (using steps 201 to 203 in FIG. 5).

The invention presents the following advantages.

The invention applies to communities that are highly dynamic, evolutive and heterogeneous. Prior art solutions do not apply in such cases or are very demanding to the main user, who is rather a network administrator than for instance a domestic user.

Due to low administration needs, the invention is convenient for large networks.

There is no need of central device, such as a control, that would play a specific role during insertion, removal or banishment. This makes the invention more robust regarding unavailability of some devices in the networks. In case of implementation within electronic chips, there is no need of specific controller version: chips are all undifferentiated.

The invention allows secure distribution of any information relevant to the community. These include, but are not limited to: configuration information, time and time-stamping information, third party protocol keys, third party mobile agents, antiviral signature files . . . .

The invention applies to various technologies, as the agent can be inserted in most type of networking devices.

The invention applies to previously constituted communities, as well as to newly constituted communities: the agent can be inserted in older devices if they support enough computation and memory capacities.

The invention allows simple banishment of a lost, stolen or compromised device. Other state of the art solutions don't provide easy means for banishing a device that is not accessible anymore.

The invention insures correct information synchronization and diffusion between community devices. This point allows transmission of third party cryptographic material for use by other protocols or system. As a non-limitative list of examples, the invention can transmit:

Shared secrets for use as keys

Cryptographic digest of files that will be transmitted over possibly insecure protocols (such as FTP). These files may be software patches, virus lists, automated security procedures . . . .

Cryptographic signatures of new versions of software agents (as the one used by the invention).

1. A device adapted to belong to a community of networked devices, said device comprising:
a provable identity and/or means for generating and/or obtaining a provable identity;
means adapted to store information about devices of the community having trust relationships with said device;
means adapted to store information about devices not trusted by said device; and
means for trust relationships synchronization.

2. The device according to claim 1, wherein said means for storing information about devices not trusted by said device stores information comprising information about devices of the community having had trust relationships with said device in the past but not having anymore.

3. The device according to claim 1, wherein the information about devices comprises the provable identity of said devices.

4. The device according to claim 1, wherein said device is furthermore designed to store information comprising proofs received from other devices of the community that said device is trusted by other devices.

5. The device according to claim 1, wherein said means for trust relationship synchronization comprise means to exchange information with other devices of the community about devices trusted and/or not trusted by other devices of the community.

6. The device according to claim 1, wherein said device comprises:
a first object capable of containing identities of devices trusted by said device and trusting said device;
a second object capable of containing identities of devices trusted by said device; and
a third object capable of containing identities of devices distrusted by said device.

7. The device according to claim 6, wherein said device is able to modify the content of said first object and/or said second object and/or said third object as a function of information exchanged with other devices of the community.

8. The device according to claim 6, wherein said first object and/or said second object and/or said third object are furthermore able to contain cryptographic material.

9. The device according to claim 6, wherein said first device is furthermore able to banish another device of said community if the identity of said device to be banished is contained in the first or the second object of said first device, said banish operation comprising removing the identity of said device to be banished from said first or second object and inserting said identity in said third object of said first device.
